(19) United States
(12) Patent Application Publication
(10) Pub. No.: US 2003/0046360 A1
(43) Pub. Date: Mar. 6, 2003

(54) Method and system for virtual window shopping

(76) Inventor: Henry E. Argasinski, Harper Woods, MI (US)

Correspondence Address: HARNESS, DICKEY & PIERCE, P.L.C., P.O. BOX 828, BLOOMFIELD HILLS, MI, 48303, US

(21) Appl. No.: 09/923,645

(22) Filed: Aug. 7, 2001

(51) Int. Cl. G06F 15/16

(52) U.S. Cl. 709/217

(57) ABSTRACT

A method for providing retailer information to a remote customer includes the steps of: providing an internet site hosted by at least one computer server in communication with a remote customer computer, communicating with the at least one computer server through the internet site, transposing an actual image of a retail environment as a navigable image within the internet site, providing functions to navigate the navigable image within the internet site, and providing customer selectable links for providing detailed information of a particular retailer of the retail environment. The method may further include transposing an actual image of the particular retailer as a navigable image within the internet site, and providing customer selectable links for providing detailed information of a particular retailer. Additionally, the method may include a purchasing interface whereby the remote customer may arrange for remote purchase of one of goods and services from the particular retailer.

### FIELD OF THE INVENTION

The present invention relates to systems and methods of conveying retail information to consumers and more particularly to a system and method for virtual window shopping.

### BACKGROUND OF THE INVENTION

Retailers continuously seek to advertise or otherwise make aware to the public, goods and services that they offer. Concurrently, retail environments, such as downtown areas of cities, shopping centers and the like function as a group, seeking to attract consumers to the group location. In many instances, local chambers of commerce seek to promote their respective communities and the goods and services the retailers of their communities provide.

The development of the Internet has provided a powerful tool for individual retailers to advertise and sell their goods to a broader market. However, the present on-line browsing and shopping experience is far removed from what a consumer would actually experience in a retail environment. Such a dichotomy between actual shopping and on-line shopping experiences can work to the detriment of on-line sales and marketing.

It is therefore desirable in the industry to provide a means for remote consumers to access information on retailer groups or otherwise remotely tour remote retail locations, which is more representative of an actual browsing/shopping experience.

### SUMMARY OF THE INVENTION

Accordingly, the present invention includes a method of providing retailer information to a remote customer, comprising the steps of: providing an Internet site hosted by at least one computer server in communication with a remote customer computer through a computer network, communicating with the at least one computer server through the internet site, transposing an actual image of a retailer group as a navigable image within the internet site, providing functions for navigating the navigable image within the internet site, and providing customer selectable links within the navigable image for providing detailed information of a particular retailer. The method of the present invention further includes the step of transposing an actual image of an interior of the particular retailer as a navigable image within the internet site.

Further areas of applicability of the present invention will become apparent from the detailed description provided hereinafter. It should be understood that the detailed description and specific examples, while indicating the preferred embodiment of the invention, are intended for purposes of illustration only and are not intended to limited the scope of the invention.

### BRIEF DESCRIPTION OF THE DRAWINGS

The present invention will become more fully understood from the detailed description and the accompanying drawings, wherein:

FIG. 1 is a schematic view of a computer network such as an Internet or Intranet;

FIG. 2 depicts a navigable retailer group according to the principles of the present invention;

FIG. 3 depicts a detailed interior view of a particular retailer of the navigable retailer group of FIG. 2;

FIG. 4 depicts an advertisement for a particular retailer of the navigable retailer group of FIG. 2;

FIG. 5 depicts a purchasing screen for purchasing or arranging to purchase goods and/or services according to the principles of the present invention.

### DETAILED DESCRIPTION OF THE PREFERRED EMBODIMENTS

The following description of the preferred embodiment(s) is merely exemplary in nature and is in no way intended to limit the invention, its application, or uses.

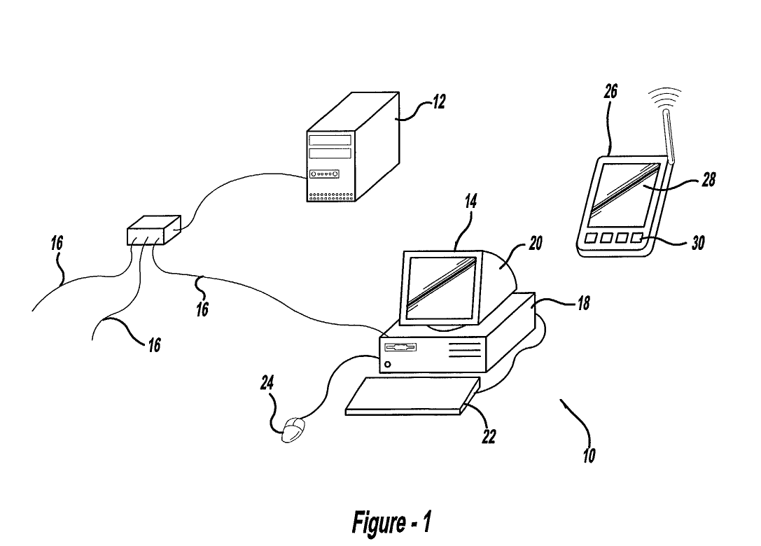

With particular reference to FIG. 1, a computer network 10, such as the Internet, is shown and includes at least one server 12 and at least one remote computer 14 in communication with the server 12 via communication lines 16. It is anticipated that the computer network 10 can include multiple servers 12 and multiple remote computers 14. The remote computer 14 includes a central processing unit 18, a monitor 20 for displaying graphics and information, a keyboard 22 and a mouse 24 for inputting information. The remote computer 14 may also include a touch-pad or other apparatus known in the art for inputting information. Also shown is a hand-held, portable computing device 26 that provides wireless web-access, enabling communication with the server 12. The hand-held device 26 includes a monitor 28 for displaying graphics and information and an input means 30. The server 12 is programmed using HTML and Javascript programming languages to host an Internet site, in accordance with the present invention, which is accessible by the remote computer 12, and hand-held device 26.

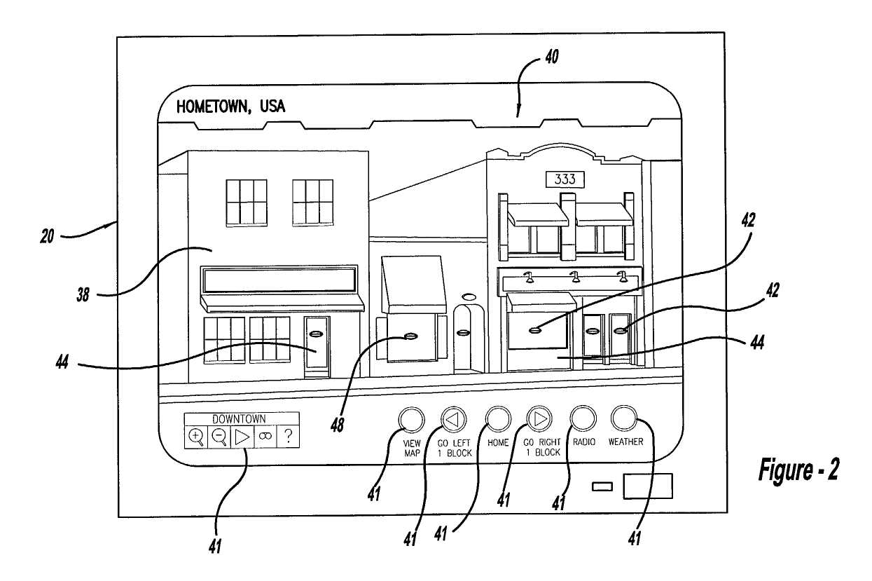

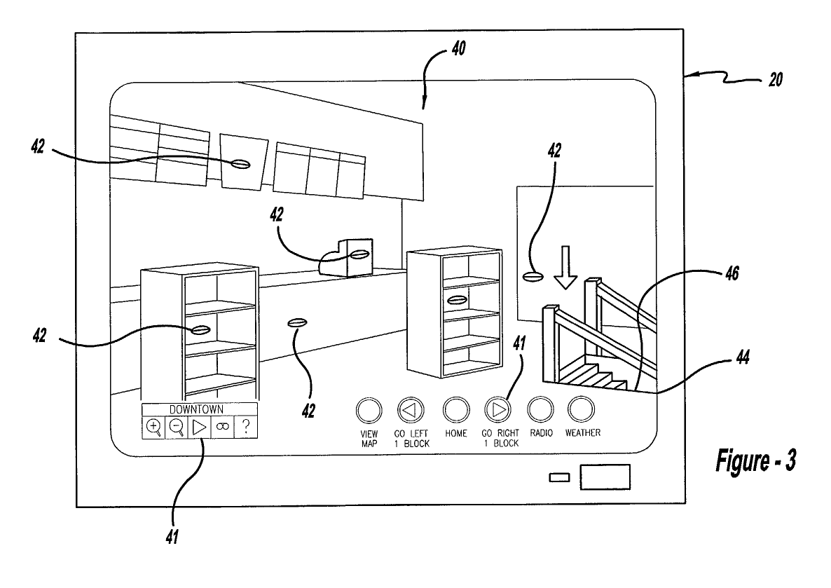

With reference to FIGS. 2 through 4, the Internet site (hereinafter “the site”) of the present invention will be described in detail. The site 40 is graphically displayed on the monitor 20, 28 of the remote computer 14 or handheld device 26 and is navigable by a remote consumer or virtual shopper via the keyboard 22, the mouse 24, or the like. The site enables the virtual shopper to select a desired, regional retail location for navigating a graphical representation of the retail location 38. The site provides a series of command buttons 41 that the virtual shopper selectively manipulates to navigate the retail location. The command buttons 41 preferably include forward, left, right, zoom-in, zoom-out, help and any other command desired.

In an exemplary embodiment, the retail location 38 is the downtown area of an actual city. It will be appreciated, however, that the retail location 38 may vary and include a strip mall, a shopping mall, an outlet center, or the like. The site provides the virtual shopper with a region-based list or a region-based graphical display of retail locations 38. The virtual shopper selects the desired retail location 38 and the site provides a detailed graphical view of the selected retail location 38. Alternatively, however, the site may be one sponsored by a particular community designed to generally promote the community. As an option within the site, the site provides a detailed graphical view of the retail environment of the particular community.

The detailed graphical view of the retail location 38 includes an actual image of the retail location, which has been transposed as a navigable image within the site. Effectively, the virtual shopper sees the retail location 38 through an actual shopper's point-of-view, as if he/she were actually present at the retail location. The site enables the virtual shopper to virtually “walk through” the retail location 38, using the command buttons 41, looking at images of actual retail shops within the retail location 38. As the virtual shopper navigates, the images scroll to provide the feel of walking through the retail location. It is anticipated that the retail shops include those selling goods (such as clothing, furniture, antiques, food and the like), restaurants, bars, art galleries and any other retail or professional establishments desired.

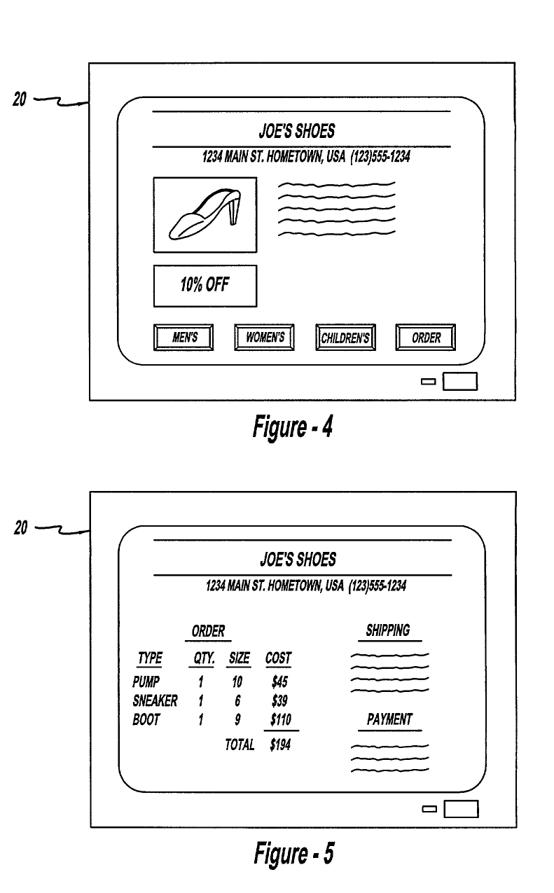

Intermittently dispersed throughout the images of the retail location 38 are links, or “hot-spots” 42, which the virtual shopper may “click-on” or otherwise select for linking the virtual shopper with more particular information regarding the retail location 38 or a particular retail shop 44 within the retail location. Certain links enable the virtual shopper to focus on the particular retail shop 44, whereby the site provides a detailed graphical view of the front of the selected retail shop 44. The detailed view of the front of the selected retail shop 44 also includes links 42 that enable the virtual shopper to focus on particular items of the selected retail shop 44 or gather particular information on the shop 44, such as address, phone number, fax number, web address, business hours, etc. A link 42 may also initiate an advertisement page (as shown in FIG. 4) for the particular retail shop 44 to be displayed for the virtual shopper's view.

Further links 42 enable the virtual shopper to “enter” a particular retail shop 44, whereby the site provides a detailed graphical view of an actual interior 46 of the retail shop 44. The interior view is navigable, whereby the virtual shopper may “walk through” the interior 46 of the retail shop 44 to view goods and the like. Again, links 42 are included for providing the virtual shopper with further information on the particular retail shop 44 including address, phone number, fax number, web address, business hours, etc. A link 42 may also initiate an advertisement page (as shown in FIG. 4) for the particular retail shop 44 to be displayed for the virtual shopper's view.

With particular reference to FIG. 5, a screen image 50 is shown whereby the virtual shopper may purchase or arrange for purchase, any number of goods or services sold by the retail shop 44. It is anticipated that the virtual shopper may scroll through a number of screens for selecting the desired goods and services, inputting payment information, inputting delivery information and the like. It is also anticipated that the site includes links 42 for enabling the virtual shopper to arrange for purchase of goods or services or actually purchase goods or services from particular retailers.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of providing retailer information to a remote customer, comprising the steps of:
providing an internet site hosted by at least one computer server in communication with a remote customer computer through a computer network;
communicating with said at least one computer server through said internet site;
transposing an actual image of a retail environment as a navigable image within said internet site;
providing functions to navigate said navigable image within said internet site; and
providing customer selectable links within said navigable image for providing detailed information of a particular retailer of said retail environment.

2. The method of providing retailer information to a remote customer of claim 1, further comprising the steps of:
transposing an actual image of an interior of said particular retailer as an alternative navigable image within said internet site; and
providing customer selectable links within said alternative navigable image for providing detailed information of a particular retailer.

3. The method of providing retailer information to a remote customer of claim 1, further comprising the steps of:
providing customer selectable links within said navigable image for providing detailed information of particular goods of a particular retailer.

4. The method of providing retailer information to a remote customer of claim 2, further comprising the steps of:
providing customer selectable links within said alternative navigable image for providing detailed information of particular goods of a particular retailer.

5. The method of providing retailer information to a remote customer of claim 1, wherein said retail environment is a downtown area of a community.

6. The method of providing retailer information to a remote customer of claim 1, wherein said retail environment is a shopping center.

7. The method of providing retailer information to a remote customer of claim 1, wherein said retail environment is a strip mall.

8. The method of providing retailer information to a remote customer of claim 1, further comprising the step of:
providing a purchasing interface whereby the remote customer may arrange for remote purchase of one of goods and services.
